(19) United States
(12) Patent Application Publication
(10) Pub. No.: US 2025/0044202 A1
(43) Pub. Date: Feb. 6, 2025

(54) STRESS WAVE PROPAGATION THROUGH A 180 DEGREE BEND JUNCTION

(71) Applicants: University of Florida Research Foundation, Inc., Gainesville, FL (US); Mississippi State University, Starkvile, MS (US)

(72) Inventors: Ghatu Subhash, Gainesville, FL (US); Wilburn Whittington, Starkville, MS (US); Richard Y. Leonard, Madison, AL (US)

(21) Appl. No.: 18/791,898

(22) Filed: Aug. 1, 2024

Related U.S. Application Data
(60) Provisional application No. 63/516,989, filed on Aug. 1, 2023.

(51) Int. Cl. G01N 3/34; G01N 3/06

(52) U.S. Cl. CPC G01N 3/34; G01N 3/066

(57) ABSTRACT

The present disclosure presents pressure bar testing systems, methods, and apparatuses. One such apparatus comprises a millipede bar having a plurality of bar segments joined at alternate ends with 180 degree bend junctions in a serpentine pattern forming a continuous path for wave propagation, wherein the plurality of bar segments comprise a central primary bar surrounded by two groupings of secondary bars, wherein the central primary bar has an impact-end and an opposite end that connects to adjacent secondary bars with 180 degree bend junctions, wherein the adjacent secondary bars belong to the two groupings of secondary bars.

### CROSS-REFERENCE TO RELATED APPLICATION

This application claims priority to co-pending U.S. provisional application entitled, “Stress Wave Propagation Through a 180 Degree Bend Junction in a Square Cross-Sectional Bar,” having application No. 63/516,989, filed Aug. 1, 2023, which is entirely incorporated herein by reference.

### BACKGROUND

Mechanical waveguides are often used in the fields of construction engineering (e.g., pile drivers, jack hammers, deep-drilling equipment) and material testing [e.g., split Hopkinson pressure bar (SHPB) or Kolsky bar, high frequency fatigue equipment]. These waveguides are long metal rods designed to transfer longitudinal stress pulses with minimal distortion. One of the drawbacks with the current design of such waveguides is that they can be uncompromisingly long, occupying space for several tens or even hundreds of meters which may require considerable capital investment. For example, long bars spanning several tens of meters are used in few laboratories in the United States. In one extreme case in Italy, an SHPB with a length of over 200 m is employed in an outdoor setting with separate concrete rooms for housing the striker bar launch system, support stations along the length of the bars, and a separate chamber for mounting a test specimen. In another example, a vertical SHPB (named “Dropkinson Bar”) was developed to deliver long duration stress pulses. In all of the above cases, the primary goal is to propagate a long duration longitudinal stress pulse to obtain constitutive behavior of a test material in the intermediate strain rate range of 10¹ s⁻¹-10² s⁻¹. In other engineering fields, such as construction and drilling industries, long metal rods are used for piling columns into the ground and transmitting energy through impact to drive a tool or fracture a rock. The capital cost of such facilities is prohibitively expensive and hence, there is an acute need for compact stress mechanical waveguides.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 presents a schematic of an exemplary millipede bar with the primary and secondary bar segments in accordance with various embodiments of the present disclosure.

FIG. 2A shows finite element (FE) simulations of wave propagation revealing alternating compression and tension waves in successive bar segments of an exemplary millipede bar in accordance with various embodiments of the present disclosure.

FIG. 2B shows the boundary conditions applied to the bend junctions of the millipede bar of FIG. 2A.

FIG. 2C shows measured wave signals at indicated locations 1-5 from FIG. 2A along with comparisons to wave signals in a single straight bar at equivalent locations.

FIGS. 3A and 3B show 3D and 2D schematics, respectively, of a single 180° bend junction in accordance with various embodiments of the present disclosure.

FIG. 4 shows comparisons of dispersion characteristics of an exemplary millipede bar for various pulse shapes as predicted by the analytical model for three values of timescale ratios in accordance with the present disclosure.

FIG. 5 shows analytical model predictions for the behavior of the junction of an exemplary milliped bar for multiple passes of a rectangular wave in accordance with the present disclosure.

FIG. 6A shows a photographic image of a prototype of a millipede bar with strain gauges, striker, and actuation mechanism (solenoid) in accordance with various embodiments of the present disclosure.

FIG. 6B is an illustration of an exemplary millipede bar showing the location of strain gauges and clamping force applied on the bend junctions to prevent rotation in accordance with various embodiments of the present disclosure.

FIG. 6C shows experimental signals obtained from the locations of strain gauges in FIG. 6B.

FIGS. 7A-7B are schematics from the input (FIG. 7A) and output (FIG. 7B) ends of an alternative waveguide design, in accordance with various embodiments of the present disclosure, with bend junctions alternating in in horizontal and vertical planes, allowing for each junction to be constrained using clamps.

FIG. 8 presents an exemplary design of a functional split Hopkinson pressure bar (SHPB) with millipede striker, incident, and transmission bars in accordance with various embodiments of the present disclosure.

FIG. 9 presents an exemplary design of a functional split Hopkinson pressure bar (SHPB) with striker, incident, and transmission bars for a 180° bend junction connecting two parallel bar segments.

### DETAILED DESCRIPTION

The present disclosure presents a novel concept for efficient propagation of long-duration longitudinal stress waves in a slender rod of smaller footprint compared to a straight bar of equivalent acoustic length. In certain embodiments, a millipede bar concept is provided that contains several rod segments of rectangular cross section joined at alternate ends with 180° bend junctions in a serpentine fashion. Analytical and numerical analyses of wave propagation through this bend junction reveal that when the input pulse duration is significantly longer than the time required for the wave to transmit the bend-dimension, the longitudinal wave emerges undistorted on the other side of the bend junction but with an opposite sign, similar to the wave reflection at the free end of a long straight rod. Hence multiple 180° bend junctions can be used to design a millipede bar in a smaller footprint and propagate a long duration stress pulse undistorted over a long distance. However, the assumption of axial motion of the rigid junction in analytical and numerical models is impractical to implement experimentally. Therefore, an innovative design is presented that orients alternate bend junctions in two orthogonal planes, thus providing room for imposing roller supports at each bend junction for its axial motion. Exemplary millipede bars, in accordance with various embodiments of the present disclosure, can be used for various applications, such as for the design of compact split Hopkinson pressure bars.

The wave propagation phenomenon in long rods of circular cross section has been investigated since the early works of Pochhammer, Chree, Rayleigh, and others. In recent years, such investigations have extended to longitudinal wave propagation through circular rods joined at angles between 15° and 90°, V-joints with bend angles from 60° to 120°, and in square cross-sectional bars connected at a 90° bend such as those in L- and T-joints. Via exemplary millipede bars, the overall length of wave guides can be dramatically reduced, thus diminishing overall cost and footprint of equipment used in the aforementioned applications.

Most recently, inspired by the concept of a momentum trap for circular bars, Whittington et al., designed a “Serpentine Bar,” where impedance-matched concentric tubes are designed around a central solid rod. This bar-tube waveguide system is welded at alternate ends so that a stress wave could seamlessly traverse from the central solid rod to the adjacent outer tube or from one concentric tube to the next, with minimal distortion. This waveguide concept extends the effective acoustic length of the serpentine bar without extending the physical footprint of the equipment thus accommodating long-duration stress pulses. With this type of design, depending on the number of coaxial tubes, a long duration stress wave of significantly longer acoustic length can be accommodated compared to a bar of same physical length. For example, a 355.6 mm (14 in) serpentine bar with two concentric tubes has an effective acoustic length of 812.8 mm (32 in) length. Leonard et al. conducted finite element analysis of this design concept and showed that it could be used to replace any of the bars in a traditional split Hopkinson pressure bar (SHPB) system and obtain significantly longer duration stress pulses in the same floor space. See Leonard et al., “Design Considerations for Joining of Tubular Members Subjected to Impact Loading,” J Adv Join Process 3 (2021). However, this design has a few practical limitations.

For effective transfer of a longitudinal stress wave without significant dispersion around each bend, the bar design requires constant impedance throughout the wave path including in the welded bend joints. This requirement demands that the wall-thickness of the bend connecting two adjacent segments must be carefully tapered in thickness (a time consuming and expensive machining process) as each outer tube is smaller in thickness than the adjoining inner tube. Thus, the tube thicknesses become increasingly smaller for each outer tube and hence it becomes increasingly difficult to add more than 4 or 5 tubes as the wall thickness of the outermost tube reduces to sub-millimeter range, thereby limiting the ability to transfer stress waves effectively due to the potential for tube buckling. This constraint limits the total number of tubes in the waveguide design and hence restricts the duration of the stress wave that can be accommodated. This restriction also limits the minimum strain rate that can be achieved during the deformation of a specimen in a SHPB. Moreover, due to cylindrical nature of the apparatus, the serpentine bar extends symmetrically in three dimensions as more outer tubes are added, requiring complex support structure which further adds to the high cost.

To remedy these limitations, a novel compact waveguide design, termed “millipede bar,” “millipede mechanical waveguide,” or “serpentine mechanical waveguide,” that accommodates long duration stress pulses suitable for implementation in a variety of practical applications is presented in the present disclosure. Theoretically, the design has no limitation in the length or duration of the longitudinal wave that can be accommodated. The millipede bar can be used to increase the acoustic length of a bar (e.g., in a SHPB) while simultaneously maintaining a reasonable physical length suitable for most laboratory spaces. This new design concept features a large number of square cross-sectional (or impedance matched) rods compactly placed next to each other and joined at alternate ends through 180° bend junctions. Due to the constant impedance throughout the waveguide, effective transfer of a longitudinal stress wave is expected from one rod to the next. A square or rectangular cross-section is used instead of a circular cross section for ease of manufacturing. However, in alternative embodiments, a circular or non-square cross-sectional rods or bars may be used.

The entire millipede bar can be cut from a single solid metal plate (in 2D) or a solid metal stock (in 3D) using wire electric discharge machining (EDM). In effect, this design acts as a single long bar which can trap a long duration longitudinal wave in a series of short rods of effective acoustic length. These features allow an SHPB to be designed for the low-end range of the intermediate strain rate mechanical testing by shortening the overall length of the straight bars from several tens of meters down to the order of few meters without reducing the overall acoustic length.

In various non-limiting embodiments, the millipede bar concept includes several parallel rod segments of square cross-section, each joined to the next with a 180° bend junction in a serpentine fashion to form a continuous path for wave propagation. This waveguide concept is rooted in the principles of 1D stress wave propagation through a constant impedance bar despite numerous wave path reversals through several bends. As stated, a square cross-sectional rod is used instead of a circular cross section due to the ease of fabrication of the millipede bar from a rectangular metal plate using electric discharge machining (EDM). Previous studies by the inventors and others have shown that that (i) rectangular cross-sectional bars can be effectively used instead of circular cross-sectional rods, (ii) the dispersion characteristics of a propagating compression wave in such rectangular bars are the same as those in circular rods of equal area, and (iii) a longitudinal stress pulse with a long wavelength can propagate with minimal dispersion as long as the length of the bar is significantly longer than its lateral dimension.

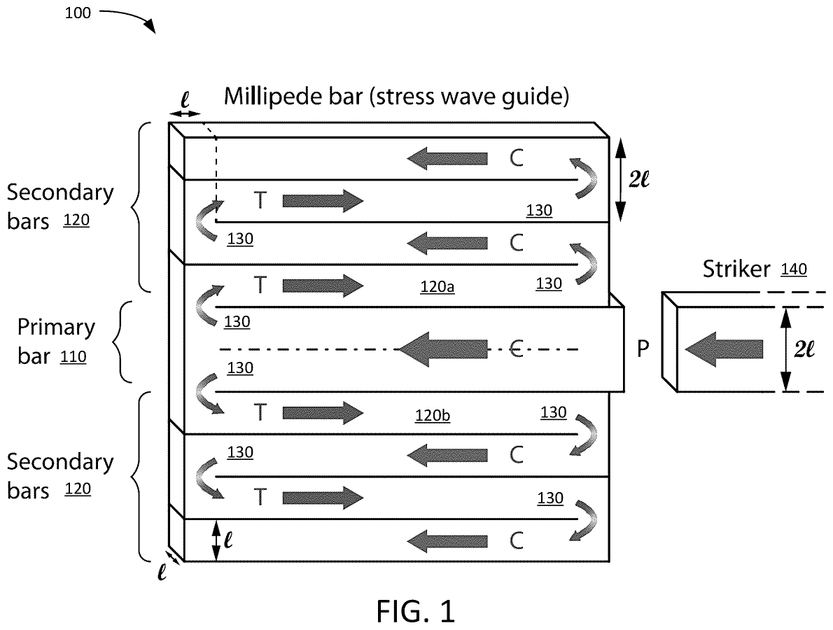

A schematic of an exemplary 2D millipede bar design 100 with one central primary bar 110 of rectangular cross-section and a grouping 120 of four secondary bars of square cross-section extending equally on either side is shown in FIG. 1. In the figure, C denotes a compressive wave and T denotes a tensile wave, and arrows indicate the direction of wave propagation.

The central bar 110 has one free end (called impact-end) P, and, on the other end, connects to two secondary rods or bars (within grouping 120) on opposite sides with 180° bend junctions 130. These secondary bars have the same cross-sectional areas (or impedances), equal to half that of the primary bar 110. This design feature not only allows the smooth transfer of stress waves from the central bar to the two parallel secondary bars, but also provides momentum and force balance at this end as the wave splits in the two directions. The number of secondary bars in the grouping 120 can be extended on either side as desired. Upon impact at ‘P’ by a long ‘striker’ 140 (see FIG. 1) of same cross section as that of the central bar 110, a longitudinal compression stress wave is generated in the central bar 110 and propagates to the other end where the stress wave splits and enters the two adjacent secondary bars 120a, 120b in the opposite direction as illustrated with arrows. This equal partitioning of the stress wave prevents the bending of the central bar 110 to either side. Upon the arrival of the stress wave at the junction end 130 of the central bar 110, the axial force pushes the junction in the same direction, and this motion loads a tensile pulse into the two secondary bars 120a, 120b. This wave now travels in the opposite direction to the wave in the central bar 110. This complete reversal of stress path through the bends 130 renders the incident compression (C) pulse in the central rod 110 into a tensile (T) pulse in the secondary bars 120, similar to the wave behavior at a free end of a straight rod. This process of stress reversal repeats at each bend junction 130 as the wave traverses all the segments of the millipede bar 110 and reaches its free ends, where it reflects and returns along the same path (again alternating between tension and compression at each bend) to the impact end ‘P’ as a tension wave and the process repeats. Thus, the millipede bar 100 with the above design features follows one-dimensional stress wave propagation principles similar to a long rod of equivalent acoustic length.

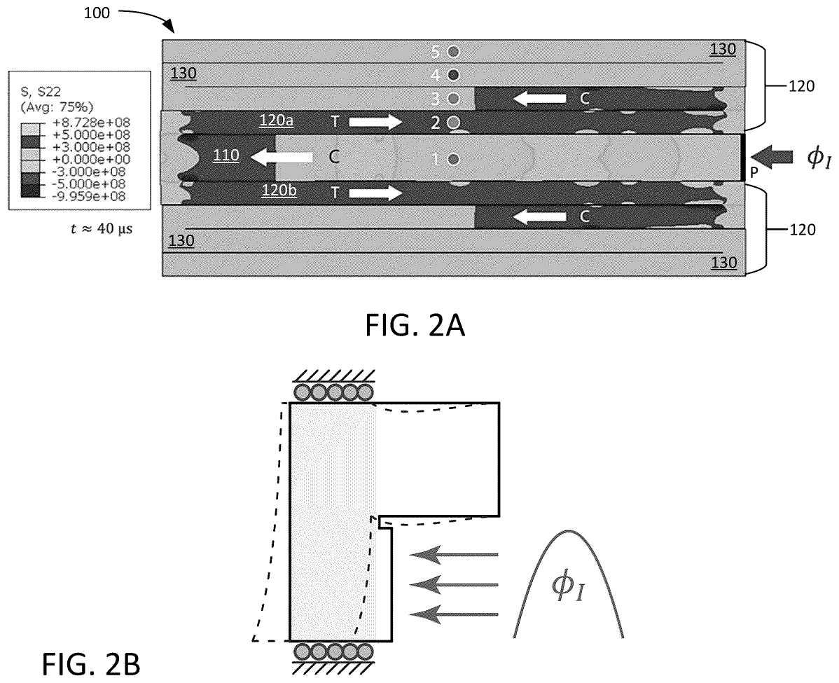

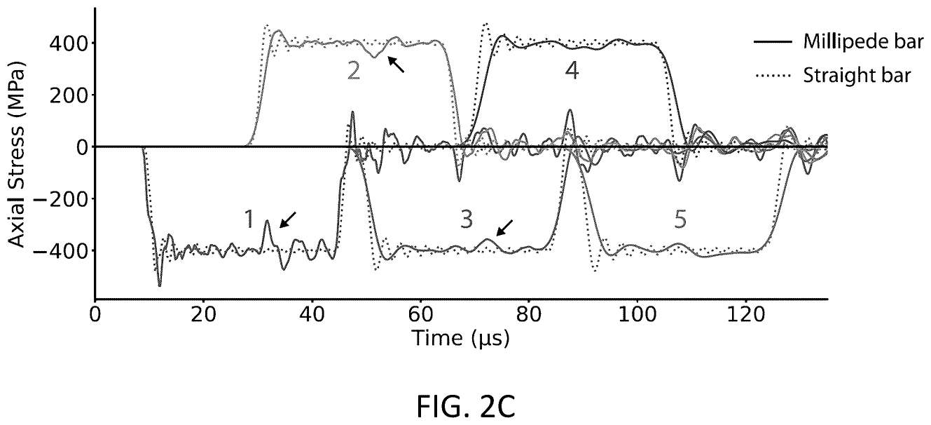

To validate this concept, finite element (FE) simulations were conducted in ABAQUS/CAE 2017. The millipede bar 100 was modelled with a grouping 120 of 4 secondary bar segments on either side of the central (primary) bar 110 of 8 mm×4 mm cross-section and the secondary bars (withing grouping 120) of 4 mm×4 mm dimension, as shown in FIG. 2A. All the bars were 100 mm in length, separated by a 0.1 mm gap. The model was meshed using CPS4R 4-node elements of characteristic size 0.1 mm, resulting in a total of 16,369 elements. The material properties selected were that of A36 steel with Young's modulus (E)=200 GPa, Poisson's ratio (ν)=0.26, and density (ρ)=7850 kg/m³. These properties result in a bar wave velocity, c₀=5048 m/s, which corresponds to a transit time of 0.0198 us through one element. The explicit finite element simulations were run at a time increment of 0.01 μs. A longitudinal stress wave of 35.4 μs duration was input at the end P in the central bar 110 mimicking a compressive (C) stress wave generation by a striker bar. The bend junctions were constrained to move only along the direction of travel, as shown in FIG. 2B. No other boundary conditions were imposed along the length of the bars.

A snapshot of the FE model with stress wave negotiating four bend junctions (two on either side of the central bar) is shown in FIG. 2A. The impact-generated compression wave in the central bar is shown by the “C arrow” and the transmitted wave to the two adjacent rod segments 120a, 120b is shown by the “T arrow” indicating the stress reversal [tension (T)] upon navigating through the first set of 180° bend junctions. The wave is again reversed into a compression wave after it navigates through the second set of bend junctions. The stress wave profiles, measured during the wave propagation through the millipede bar at locations 1 through 5 in the various bar segments, are shown in FIG. 2C. Note the alternating stress between compression and tension in successive bar segments. Upon reaching the free-end of the segment 5, the stress wave would reflect and travel back along the same path (again alternating between T and C in adjacent bar segments) to the impact end as a tension wave, exactly like the 1-D wave propagation behavior in a single straight rod. To prevent the superimposition of this reflected wave from the free end, segment 5 was extended in this study. From the wave profiles at points 1 and 4, we can observe that the stress wave has not deteriorated significantly in its amplitude and duration despite passing through three 180° bends 130, and the pulses become smoother as they “flow” through each bend 130.

To make a comparison with the signals from the millipede bar with those from a straight bar, separate FE simulations of wave propagation in a long straight bar were conducted and these results at equivalent locations are shown with dotted lines in FIG. 2C. The signals at equivalent points 2 and 4 for this straight bar are flipped to tension so that they can be directly compared to the signals from the millipede bar. Note that both the signals are very similar in amplitude and width, showing that the propagation of stress waves through the millipede bar is analogous to propagation through a single long bar. The most obvious difference is the loss of high frequency components in the millipede bar after the wave passes through each first junction, which also results in a slight delay to the signal arriving at each location. These high frequency components are reflected at the bend junction and are superimposed on the incoming wave, resulting in some minor distortions in the second half of each measured pulse, as shown by the black arrows in FIG. 2C.

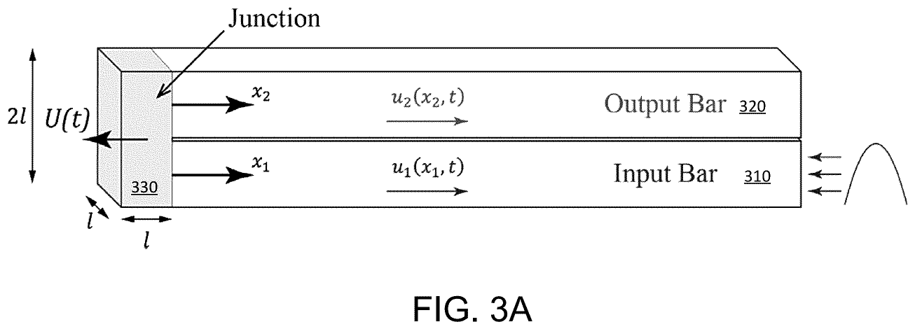

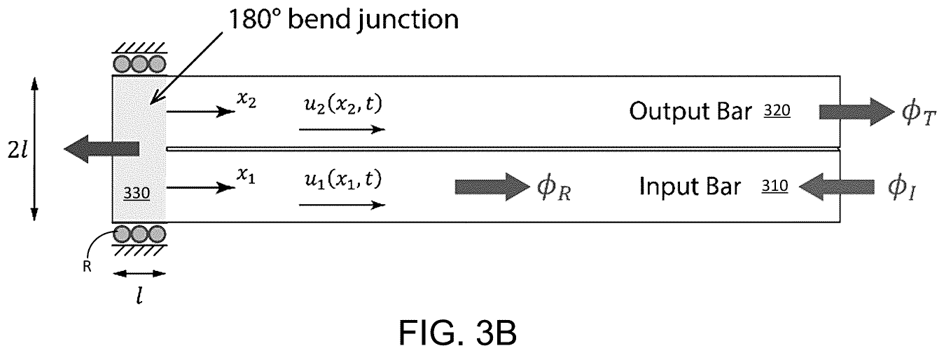

To further understand the fundamental mechanism of wave transfer through the millipede bar 100, the behavior of the 180° bend junction connecting two parallel bar segments, is analyzed in FIGS. 3A-3B. Accordingly, a schematic of the 180° bend junction 330 between two solid rods 310, 320 of square cross-section of side/and separated by an infinitesimally small gap is shown in FIGS. 3A-3B. The entire assembly has the same impedance at all cross-sections along the wave path and the bar material is assumed to be isotropic, homogeneous, and linear elastic. The location of the junction 330 connecting the two rods is set at x₁=x₂=0. An incident longitudinal wave from the input bar 310 enters the junction 330 from the negative x-direction and emerges in the output bar 320. To understand the influence of the junction on the relationship between the incident, reflected, and transmitted waves, wave propagation effects in the bars are ignored and only the bar lengths are considered that accommodate the pulses of given duration just before entering and after emerging out of the junction. Note that five out of six surfaces of the junction 330 (shaded region in FIG. 3A) connecting the two bars 310, 320 are stress free. Hence, any stresses induced within the junction 330 due to stress wave propagation should be sufficiently smaller than the stress generated in the bars 310, 320. Therefore, a principal assumption for the analytical model is that the junction 330 only undergoes rigid motion. The one-dimensional nature of the analytical model also assumes that there is no rotation or significant transverse motion of the junction 330 (i.e., no shearing or bending). The validity of these assumptions will be assessed later through finite element simulations. The axial displacements in the input and output bars 310, 320 during the longitudinal wave propagation are denoted by u₁(x₁,t) and u₂(x₂,t), respectively. The characteristic equation for one-dimensional wave propagation is given by

$$\frac{{\partial }^{2} {u}_{i}}{\partial {x}_{i}^{2}} = \frac{1}{{c}^{2}} \frac{{\partial }^{2} {u}_{i}}{\partial {t}^{2}} , i = 1 , 2 \qquad ( 1 )$$

where, c=\sqrt{E/ρ} is the propagation velocity of the longitudinal wave in the bars, E is the Young's modulus, ρ is the density of the material, and t is time (t=0 when the leading edge of the wave reaches x₁=0). The solution to Eq. 1 can be written for the input and output bars as

$${u}_{1} ( {x}_{1} , t ) = {φ}_{I} ( t + {x}_{1} / c ) + {φ}_{R} ( t - {x}_{1} / c ) \qquad ( 2 a )$$

$${u}_{2} ( {x}_{2} , t ) = {φ}_{T} ( t - {x}_{2} / c ) \qquad ( 2 b )$$

where φ₁, φ_{R}, and φ_{T} represent the displacement amplitudes of the incident, reflected, and transmitted waves, respectively. The boundary conditions can be envisioned from the assumption that the junction undergoes rigid motion, as

$${u}_{1} ( 0 , t ) = {u}_{2} ( 0 , t ) = - U ( t ) \qquad ( 3 )$$

where U represents the displacement of the center of mass of the junction, as shown in FIG. 3A. Eqs. 2a, 2b, and 3 can be combined to obtain

$${φ}_{I} ( t ) + {φ}_{R} ( t ) = - U ( t ) \qquad ( 4 )$$

$${φ}_{T} ( t ) = - U ( t )$$

The axial strains along the centerline of the rods can be obtained by differentiating u₁ and u₂ in Eqs. 2a and 2b with respect to the spatial coordinates,

$$\frac{\partial {u}_{1}}{\partial {x}_{1}} = \frac{1}{c} ( \frac{\partial {φ}_{I}}{\partial {x}_{1}} - \frac{\partial {φ}_{R}}{\partial {x}_{1}} ) \qquad ( 5 )$$

$$\frac{\partial {u}_{2}}{\partial {x}_{2}} = - \frac{1}{c} ( \frac{\partial {φ}_{T}}{\partial {x}_{2}} )$$

The corresponding axial forces generated in each bar, F₁ and F₂, respectively, are

$${F}_{i} ( {x}_{i} , t ) = AE \frac{\partial {u}_{i}}{\partial {x}_{i}} = A ρ {c}^{2} \frac{\partial {u}_{i}}{\partial {x}_{i}} , i = 1 , 2 \qquad ( 6 )$$

where A=l² is the cross-section area of each bar. Newton's second law can be directly used to describe the movement of the rigid junction, i.e., the inertial force must balance the forces exerted by the bars, and hence

$${F}_{1} + {F}_{2} = - m \ddot{U} \qquad ( 7 )$$

where m=2Aρl is the mass of the junction. Assuming that the input wave characteristics (i.e., the shape, amplitude, and duration of φ₁) are known, Eqs. 4-7 represent a system of seven partial differential equations with seven unknowns. Substituting Eqs. 4-6 into Eq. 7, we obtain

$$A ρ c [ \frac{\partial {φ}_{I}}{\partial {x}_{1}} - \frac{\partial {φ}_{R}}{\partial {x}_{1}} - \frac{\partial {φ}_{T}}{\partial {x}_{2}} ] = - m \ddot{U} \qquad ( 8 )$$

For this problem, it is convenient to work in Laplace domain (assuming quiescent initial condition). After applying Laplace transforms to Eqs. 4-8 and solving, we obtain

$${\hat{ϕ}}_{T} ( s ) = \frac{{\hat{ϕ}}_{I} ( s )}{1 + \frac{m}{2 A ρ c} s} = H ( s ) {\hat{ϕ}}_{I} ( s ) \qquad ( 9 )$$

Here, \hat{φ}(s)=L[φ(t)], where L stands for the Laplace transform. This result does not presuppose any particular form of φ₁(t), and hence, applies to any type of incoming waveform. The transfer function, H(s), relates the transmitted wave characteristics to that of the incident wave and encodes the effect of 180° bend. Note that the displacement in the output bar (\hat{φ}ₜ) has the same sign as that of the input bar (\hat{φ}_{T}), i.e., the particle motion in the output bar is in the same direction as that in the input bar. As the wave propagates in the positive x-direction in the output bar, this result implies that the transmitted wave is tensile in nature. The second term in the denominator of the transfer function is the ratio of mass of the junction to the impedance (2Aρc) of the rod in 1-D stress condition, and it can be rewritten as,

$$\frac{m}{2 A ρ c} = \frac{2 A ρ l}{2 A ρ c} = \frac{l}{c} = {T}_{ch} \qquad ( 10 )$$

where T_{ch} is the characteristic time, defined as the time required for the longitudinal elastic wave (with velocity c) to traverse the junction of dimension l. Hence, the transfer function can be written in terms of this characteristic time as

$$H ( s ) = \frac{{\hat{φ}}_{T} ( s )}{{\hat{φ}}_{I} ( s )} = \frac{1}{1 + {T}_{ch} s} \qquad ( 11 )$$

Since the transfer function intrinsically contains the characteristic time, it hints that the model extends beyond 3D systems and that it can provide results in quasi-2D configurations as well, e.g., plane stress or plane strain, thus, allowing for simpler finite element models to be assumed for analysis and comparison of results. The emerging (transmitted) wave out of the junction into the output rod can be computed in the time domain as

$${ϕ}_{T} ( t ) = \int {\hat{ϕ}}_{T} ( s ) {e}^{st} d s = \int \hat{{ϕ}_{I}} ( s ) H ( s ) {e}^{st} ds = \int \frac{{\hat{ϕ}}_{I} ( s )}{1 + {T}_{ch} s} {e}^{st} ds \qquad ( 12 )$$

Appealing to the convolution integral, Eq. 12 can be equivalently expressed explicitly in the time domain as

$${φ}_{T} ( t ) = {\int }_{0}^{t} \frac{{e}^{- τ / {T}_{ch}}}{{T}_{ch}} {φ}_{I} ( t - τ ) d τ \qquad ( 13 )$$

It is important to acknowledge that the transfer function in Eq. 11 changes meaningfully over frequency increments ˜1/T_{ch}, while the exponential kernel in Eq. 13 does the same for time increments ˜T_{ch}. If we assume that the input pulse φ_{I}(t) is of finite shape, with a duration Tₚ (subscript p refers to pulse), then the interplay between these two timescales will define the qualitative behavior of the junction and the output wave characteristics. Therefore, we define the ratio between these two timescales as

$${T}^{*} = \frac{{T}_{p}}{{T}_{ch}} = \frac{c {T}_{p}}{l} \qquad ( 14 )$$

It is noted that this dimensionless ratio can also be interpreted in terms of characteristic length, namely, the ratio of the dominant wavelength (or pulse width) of the input wave (cTₚ) to the size of the junction (l). Depending on the range of values of T*, two major qualitative scenarios can be envisioned:
1. Long pulse, i.e., T*>>1: If the input pulse width (Tₚ) is significantly longer than the characteristic time (T_{ch}), then in the denominator of Eq. 11 of the transfer function, T_{ch}s=T_{ch}/Tₚ<<1 and hence, H(s)≈1. Therefore, φ_{T}(t)≈φ_{I}(t), which means that the incident wave “flows” through the junction without distortion and emerges unaltered in the output bar.
2. Short pulse, i.e., T*<<1: If the input pulse width (Tₚ) is significantly shorter than the characteristic time (T_{ch}), H(s)≈1/s; i.e., it acts as an integrator for the time duration t≈Tₚ. Thus, the transmitted pulse behavior varies depending on the time in relation to the pulse duration. During this short timespan (in comparison to T_{ch}), the amplitude builds up, as

$${φ}_{T} ( t ) \approx \frac{1}{{T}_{ch}} {\int }_{( )}^{t} {φ}_{I} ( τ ) d τ \qquad ( 15 )$$

An exponential decay then follows over time increments of the order of Tch and the integral output that had been built up starts to fade as

$${φ}_{T} ( t ) \approx \frac{{e}^{- t / {T}_{ch}}}{{T}_{c h}} ( {\int }_{0}^{{T}_{p}} {φ}_{I} ( τ ) d τ ) \qquad ( 16 )$$

Of course, this decay will appear very slow in comparison to the wave duration. Hence, for longer wavelengths, the kernel acts as a Dirac delta (δ_{D}), with only a slight change in the pulse shape. However, in the case of short wavelengths, the exponential kernel acts as Heaviside function at first (times of the order Tₚ), followed by a slow decay (times of the order T_{ch}). The filtering effect becomes dominant as Tₚ approaches T_{ch} and becomes severe for Tₚ<<T_{ch}. This filtering of high frequency components in the signal is expected as the transfer function given in Eq. 11 is identical to that of a low-pass filter (LPF), which is given as

$${H}_{LPF} ( s ) = \frac{{ω}_{LPF}}{{ω}_{LPF} + s} \qquad ( 17 )$$

where ω_{LPF}=2πf_{LPF} is the cut-off frequency of the filter. Comparing Eqs. 10, 11, and 17, we get

$$2 π {f}_{LPF} = {ω}_{LPF} = \frac{1}{{T}_{ch}} = \frac{c}{l} \qquad ( 18 )$$

Hence, the junction acts as a low-pass filer (i.e., it filters out the high frequency components) with a cut-off frequency that depends on the characteristic time, such that the high frequency components are reflected from the bend junction and only low frequency components are allowed to pass. This is why the distortion in the pulses (shown by the black arrows in FIG. 2C) due to the superimposition of the reflected wave is most prevalent at location 1.

It is noted that the input and transmitted displacement amplitudes in Eqs. 9-11 have the same sign even though the waves are traveling in opposite direction. This means that the stress in the output bar should be opposite in sign compared to that in the incident bar. This relationship can also be confirmed by considering the axial stress in the bar,

$${σ}_{x} ( x , t ) = ρ c ( \frac{δ ϕ}{δ t} ) ,$$

and its Laplace transform for the stress wave, \hat{σ} (s)=ρcs\hat{φ}(s).

The amplitude of the reflected wave can be written as

$${φ}_{R} ( t ) = {φ}_{T} ( t ) - {φ}_{I} ( t ) = {\int }_{0}^{t} ( \frac{{e}^{- τ / {T}_{ch}}}{{T}_{c h}} - {δ}_{D} ( τ ) ) {φ}_{I} ( t - τ ) d τ \qquad ( 19 )$$

This kernel, for the reflected wave, “measures” how well the exponential approximates a Dirac delta function; it returns the difference between the input (Dirac delta part) and how it is seen after the junction (exponential part). For low values of T*, the dichotomy will be obvious and hence, there will be sizable reflections. However, even for high values of T*, there can be differences (and thus reflections), especially when the input pulse has high frequency components (sudden changes or oscillations). For example, if the pulse rises or falls sharply in a short time, the difference between the instantaneous delta function and the small delay associated with the exponential will be evident, creating narrow pulses being reflected back.

In summary, the analytical model predicts no meaningful reflections for an input pulse with high T* that change slowly, and sizeable reflected pulses if either T* is small or the input pulse has sudden changes in shape despite having a high T*. Hence, the dispersion characteristics of the longitudinal wave as it travels through the junction depend on the shape as well as the duration of the input pulse.

The axial stress in the bar is given by σₓ(x, t)=ρ_{c}(∂φ/∂t), and hence, for the output bar, its Laplace transform is

$${\hat{σ}}_{T} = L [ {σ}_{x} ( x = 0 , t ) ] = ρ cs {\hat{φ}}_{T} ( s ) \qquad ( 20 )$$

where it is assumed that the output bar is unperturbed at t=0 (assuming x=0 in this case represents the first section of the output rod). Likewise, we can define the Laplace transform of the incoming stress wave, so \hat{σ}_{I}=ρcsφ_{I}(s). Hence, recalling Eq. 6 and taking and multiplying both sides of Eq. 9 by pcs yields

$${\hat{σ}}_{T} ( s ) = - H ( s ) {\hat{σ}}_{I} ( s ) \qquad ( 21 )$$

In other words, the transfer function for displacements is also the transfer function for stresses. However, it is instructive to recall that the transmitted pulse through the junction is opposite in nature (note the negative sign) when compared to the input pulse, i.e., the compression pulse emerges as a tensile pulse from the 180° bend junction and vice versa.

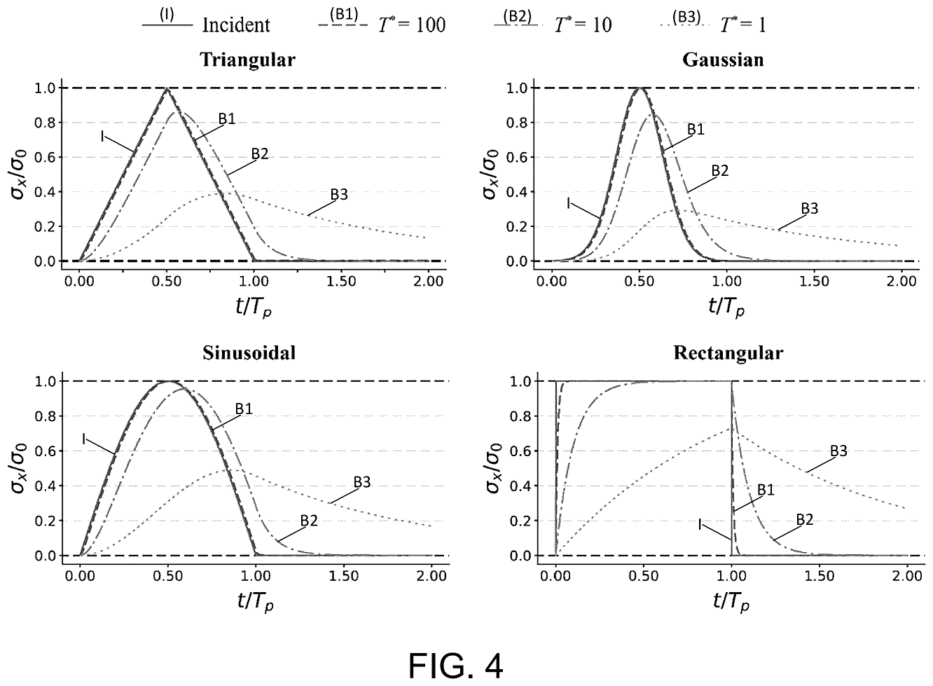

The analytical model (Eqs. 2a-21) can now be used to determine the output wave characteristics for any choice of input pulse shape ϕ_{I}(t). FIG. 4 presents the effect of a single 180° bend junction for four input pulse shapes-triangular, Gaussian, sinusoidal, and rectangular—and three T* values. Here, only the absolute value of the stress pulses is considered to highlight the influence on the magnitude of the output pulses in comparison to the input pulse. For long duration incident pulses (T*=100), the transmitted stress wave emerges practically unaltered (compare the Incident (I) and Bend Curves (B1, B2, B3); however, significant dispersive effects can be observed for lower T* values. It is also important to note that pulse shapes with long peak durations (e.g., rectangular pulse) undergo less severe dispersion than those with a sharp peak (e.g., triangular). This is clearly seen for rectangular shaped pulse where even for T*=10, the peak stress magnitude is retained in the transmitted pulse whereas a triangular pulse suffers almost 20% reduction in peak amplitude. This result is expected as the high frequency components associated with any sudden changes are not transmitted due to the LPF behavior of the junction.

Realizing the linear nature of Eqs. 9-11 and ignoring dispersion effects of wave propagation in the bar segments, the effect of N successive 180° bends is obtained by simply multiplying the transfer function N times. Hence, the relation between the stresses in the input and output segments in a millipede bar after successive propagation through N bend junctions is written from Eq. 21 in the Laplace domain as

$${\hat{σ}}_{T} ( s ) = {[ - H ( s ) ]}^{N} {\hat{σ}}_{I} ( s ) = {[ - \frac{1}{1 + {T}_{ch} s} ]}^{N} {\hat{σ}}_{I} ( s ) \qquad ( 22 )$$

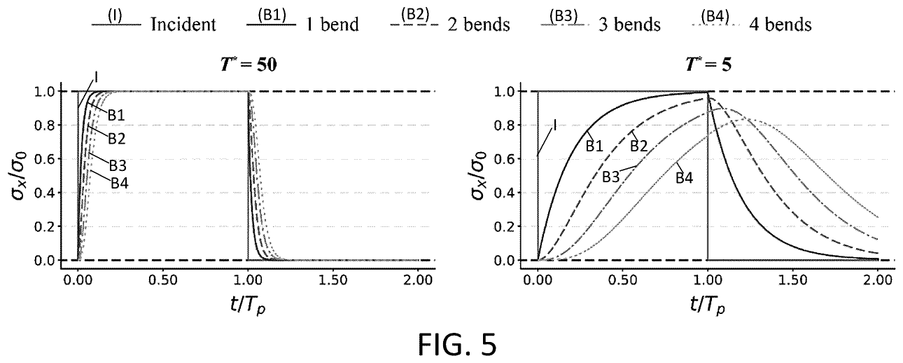

The result, transformed back into the time domain, is shown in FIG. 5 for two normalized pulse durations. Again, the sign change after the wave passes through each bend is neglected for illustration purposes. For T*=50, an initial rectangular pulse does not suffer any loss in peak amplitude but only a loss in the duration of the peak amplitude. However, for T*=5, there is a significant loss in pulse duration and a change in pulse shape as well. For both pulse durations, there is also a delay in the arrival of the pulse after traversing the bend and this delay increases with increasing number of passes.

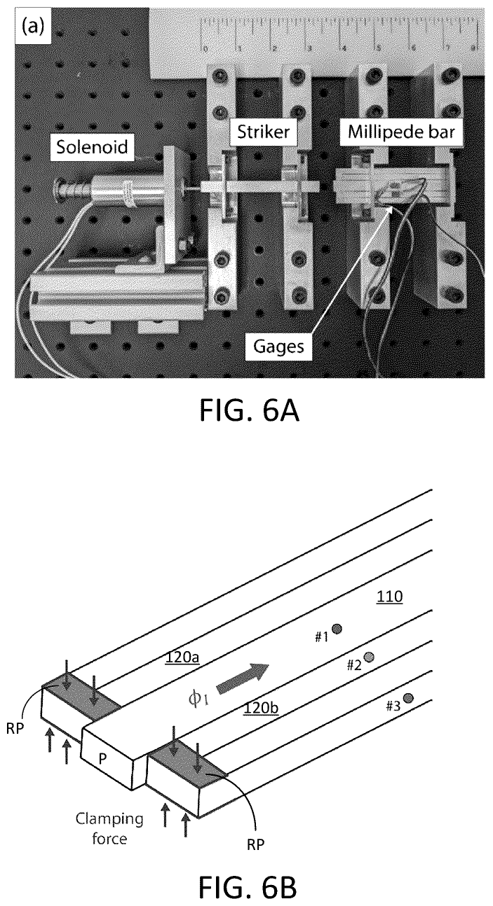

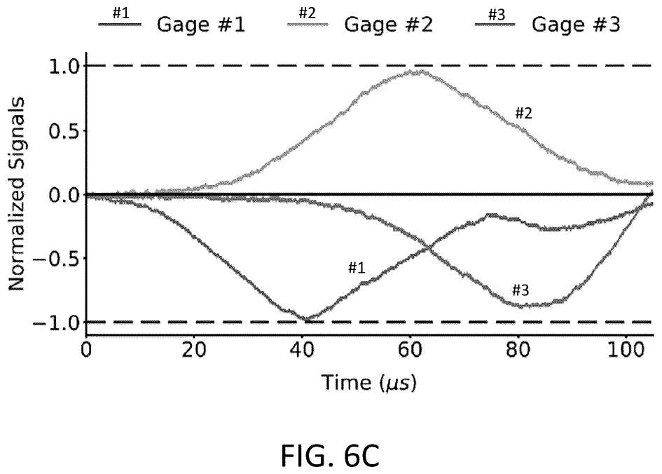

A miniature 2D millipede bar manufactured from an aluminum plate of 80 mm length and 4 mm thickness via wire EDM is shown in FIG. 6A and FIG. 6B. The central (primary) bar 110 has a width of 8 mm, and the two secondary bars segments 120a, 120b on either side are 4 mm wide. The millipede bar is mounted on a breadboard with an appropriate support system. The wire EDM process resulted in a gap of ˜0.2 mm between the bar segments. Strain gauges were bonded at the mid points on the top surfaces of the central bar (gauge #1) and the first secondary bar (gauge #2). Another strain gauge (gauge #3) was bonded on the side surface of the last bar segment, as shown in FIG. 6B. A 130 mm long striker, propelled by a solenoid, was used to impact the central rod of the millipede bar. The motion of all the bars was guided by well-aligned brass bushings. Pulse shapers (tissue paper) of different thickness were used to obtain different pulse shapes.

To mimic the ‘no rotation’ boundary condition of the bend junction used in the FE simulation (which is similar to that assumed in the analytical formulation), two rectangular plates RP on either side of the junction were held with a clamp as schematically illustrated in FIG. 6B. It is assumed that by applying sufficient frictional clamping force vertical to the plane of the bars, the bend junction would be constrained from rotating in-plane. However, it is important to note that this constraint is different from the roller boundary condition implemented in the FE and the analytical models due to the lack of space between the rod segments to impose the in-plane boundary condition. The clamp RP introduces a frictional force perpendicular to the plane of the millipede bar; while the boundary conditions in the FE and analytical models introduce a reaction force in the plane of the millipede bar.

FIG. 6C shows an example of the stress pulses measured by the three strain gauges of FIG. 6B. The incident compressive pulse (#1) measured on the central bar (at gauge #1) traverses through the first 180° bend junction and emerges in the first secondary bar segment as a tensile pulse (#2) as measured at gauge #2. This result is in accordance with the predictions of both analytical model and the FE simulations. Despite the applied boundary conditions being different from the theory, more than 95% of the amplitude has been recovered in the transmitted pulse. This is because of the symmetric nature of the first set of bend junctions, which cancels out any rotation. Upon traveling to the next bar segment, the tensile pulse emerges as a compression pulse but its amplitude and duration, measured at gauge #3, differ from those of the previous signal. This is due to several reasons: (i) Improper implementation of boundary conditions in the experiment due to the lack of space on either side of the bend junction to impose in-plane constraints; (ii) Strain gauge #3 is bonded on a plane perpendicular to that of the gauges #1 and #2 (see FIG. 6B); and hence, will also sense any flexural waves generated in that bar segment due to the junction rotation; and (iii) Some components of reflected wave from the free-end of the last bar segment are superimposed onto the incoming signal, which reduces the total amount of stress in the bar.

In various embodiments, an exemplary millipede bar has a rolling support R applied, as shown in FIG. 3B, to prevent junction rotation and minimize the dispersion of the longitudinal wave as it travels through the junction. However, the gap between each of the bar segments in the millipede bar, dictated by the EDM wire dimensions, should be as small as possible-a large gap will cause the bend junction to act as a three-bar system, introducing additional flexural waves as one end of the middle bar (forming the three-bar junction) will move farther than the other end. Hence, to ensure that a long duration longitudinal stress wave traverses unaltered through a 180° bend junction, the gap between the two bars should preferably be kept to a minimum. This, however, makes the implementation of boundary conditions non-trivial.

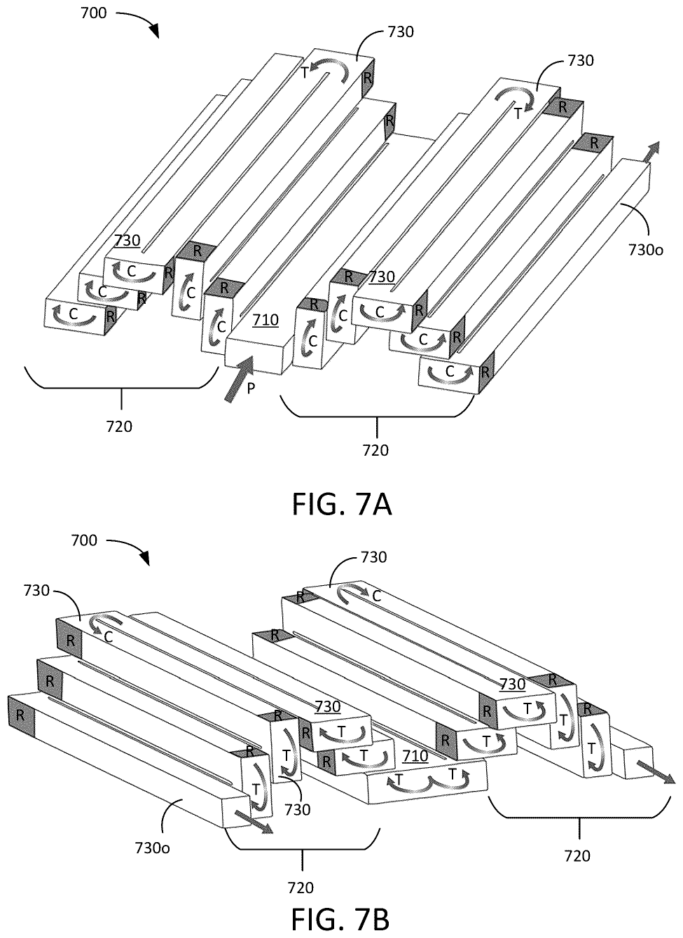

Therefore, the present disclosure presents an innovative alternate design of the millipede bar 700 having a primary bar 710 and groupings 720 of secondary bar segments, wherein each successive bend junction 730 is aligned alternatingly in horizontal and vertical planes, as shown in FIGS. 7A-7B. Two separate views, from the input (FIG. 7A) and the output (FIG. 7B) ends, are shown for better illustration of the bend junctions, the boundary conditions, and the stress wave path. The solid straight arrows indicate the input and output side of the millipede bar, whereas the curved arrows show the wave travelling through the bend junctions 730. C indicates compression and T indicates tension in the figures. The location of the roller supports, to ensure that there is no-rotation of the bend junctions, are shown in by R. Note that all the secondary rods 720 are not of the same length so that there is sufficient room to apply the correct boundary conditions. Using this modified 3D millipede bar 700, the limitations of the 2D bar discussed previously can be overcome. Additionally, the lengths of the output bar 730o segments can be increased to prevent the superposition of the reflected wave.

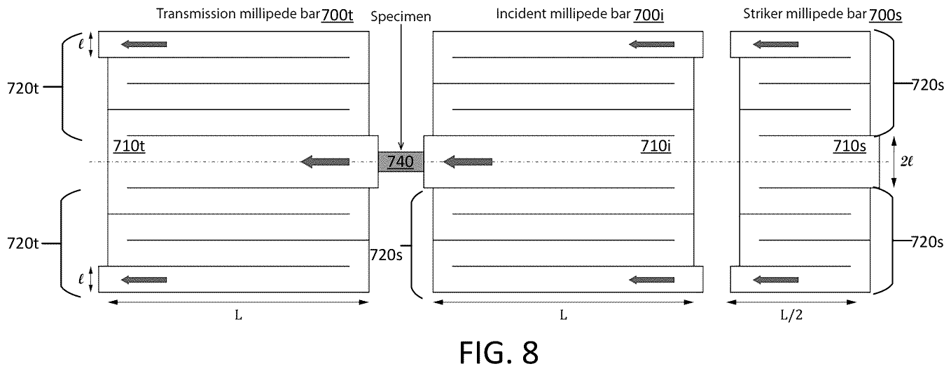

The alternative 3D millipede bar design disclosed above can be suitably introduced into a split Hokinson pressure bar setup, replacing the traditional incident and transmission bars, to reduce its footprint and yet accomplish long duration stress pulses to achieve lower strain rates in a specimen. The striker bar can be a long straight bar of rectangular cross section (similar geometry to the primary central bar) and can be launched just as in a traditional SHPB setup. However, another option is to reverse the incident bar and replace the traditional striker bar with a millipede geometry 700s, which can be pushed by another bar at a high velocity. With the latter configuration, the output bar segments of the striker millipede bar 700s impact the corresponding outer segments of the incident millipede bar 700i, as shown in FIG. 8. For simplicity, we have shown a planar (2D) millipede bar here, but the concept is the same for a bar of the 3D geometry shown in FIGS. 7A-7B. When used as an SHPB, only two strain gauges would be required per millipede bar, which can be mounted far away from the output end to prevent any effects from wave reflection. An important distinction in the output signal from an MPB is that the high frequency components in the stress pulse are filtered out at each bend (see FIGS. 2A-2C). However, the loss of high frequency components is not detrimental for intermediate strain rate experiments, which is the main benefits in using a millipede bar with a smaller footprint than a straight long bar. Further, this can be an advantage when testing a specimen 740, such as brittle materials, where pulses with slow ramps (obtained using pulse shapers) are preferred.

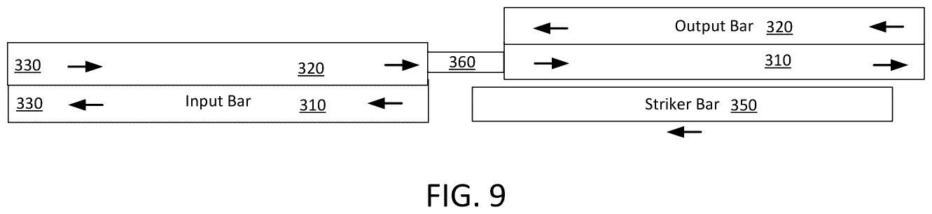

Referring now to FIG. 9, in various embodiments, a split Hokinson pressure bar setup may be implemented using the arrangement of FIGS. 3A-3B for a 180° bend junction connecting two parallel bar segments 310, 320. In this arrangement, for certain embodiments, the bars may be fabricated from A36 low-carbon steel stock cut to be 155 mm long, 10 mm wide, and 5 mm thick. A 150 mm long and 250 μm wide slot was cut via wire electric discharge machining (EDM), leaving a 5 mm width junction and a 180° bend between two square bars, each with a cross-section of ˜5×5 mm. A striker 350 with the same cross-sectional area may also be fabricated from the same steel stock. To establish planar contact between the striker 350 and the input bar 310, the faces of all bars may be ground to be flat and parallel to each other. To support the bars and the motion of the striker before impact, a polymer guide of same width as the bars may be 3D printed from High Impact Polystyrene (Z-HIPS®). In various embodiments, the 180° bend junction 330 area of the polymer guide may be clamped to allow only a sliding motion of the bars, (the same boundary condition used in the analytical and numerical models disclosed herein). The contact surfaces of the bars with the polymer guide may be lubricated to minimize friction. For the stress measurement locations, strain gauges (Micro-Measurements EA-06-031CE-350/LE) may be bonded to each bar at a distance of 62.5 mm from the edge of the junction. In various embodiments, a specimen 360 being tested can be positioned between an output/transmission bar 320 of one pair of parallel bar segments 310, 320 and an input/incident bar 310 of another parallel bar segments, as shown in FIG. 9.

In various embodiments, the testing setups of FIG. 8 and/or FIG. 9 generally involve a specimen being placed between ends of an incident bar and a transmitted bar with strain gauges on the bars measuring strains caused by a stress wave (generated from the striker bar hitting the incident bar) that is referred to as an incident wave that travels toward the specimen and a transmitted wave generated from the incident wave that travels through the specimen into the transmitted bar causing deformation in the specimen. A reflected wave is also generated by the incident wave as it encounters the specimen and travels back down the incident bar. Stress and strain can be calculated from the amplitudes of the incident, transmitted, and reflected waves.

In accordance with the present disclosure, a novel millipede bar concept, among others, is disclosed with several long bars of rectangular cross section, connected with 180° bend junctions at alternate ends in a serpentine fashion to obtain long acoustic lengths in a shorter footprint. The analytical and numerical modeling of the millipede bar reveal that when the pulse duration is significantly longer than the time required for longitudinal wave to travel through the thickness of the bend junction, the incident wave can emerge on the other side of the bend junction unaltered in its duration and amplitude. Furthermore, high frequency components in the pulses will be automatically filtered out as the stress pulses pass through each bend junction. However, the above result is possible if the bend junction is allowed to move as a rigid body in the direction of the incident wave, without rotation, which is difficult to implement in experiments due to the small gap between the rod segments. Hence, in various embodiments, the bend junctions are designed to alternate between two perpendicular planes, thus extending the millipede bar in 3D space. An exemplary millipede bar design can be implemented in a SHPB to obtain long duration longitudinal stress waves without increasing the footprint of the equipment.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y.’”

It should be emphasized that the above-described embodiments of the present disclosure are merely possible examples of implementations, merely set forth for a clear understanding of the principles of the disclosure. Many variations and modifications may be made to the above-described embodiment(s) without departing substantially from the principles of the present disclosure. All such modifications and variations are intended to be included herein within the scope of this disclosure.

We claim:

1. A pressure bar testing device comprising:
a millipede bar having a plurality of bar segments joined at alternate ends with 180 degree bend junctions in a serpentine pattern forming a continuous path for wave propagation, wherein the plurality of bar segments comprise a central primary bar surrounded by two groupings of secondary bars,
wherein the central primary bar has an impact-end and an opposite end that connects to adjacent secondary bars with 180 degree bend junctions, wherein the adjacent secondary bars belong to the two groupings of secondary bars.

2. The pressure bar testing device of claim 1, wherein the central primary bar and the secondary bars have a square cross section.

3. The pressure bar testing device of claim 2, wherein a cross sectional area of individual secondary bars is equal to half of a cross sectional area of the central primary bar.

4. The pressure bar testing device of claim 1, wherein the secondary bars are arranged in parallel to one another.

5. The pressure bar testing device of claim 1, wherein a plurality of the secondary bars are oriented such that bend junctions of the plurality of the secondary bars orient in two orthogonal planes.

6. The pressure bar testing device of claim 5, further comprising roller supports at a plurality of bend junctions that apply a clamping force to the plurality of bend junctions.

7. The pressure bar testing device of claim 5, wherein the pressure bar testing device comprises an incident bar in a compact split Hopkinson pressure bar testing system, a transmission bar in the compact split Hopkinson pressure bar testing system, or a striker bar in the compact split Hopkinson pressure bar testing system.

8. The pressure bar testing device of claim 5, wherein the pressure bar testing device comprises an incident bar in a compact split Hopkinson pressure bar testing system, a transmission bar in the compact split Hopkinson pressure bar testing system, and a striker bar in the compact split Hopkinson pressure bar testing system.

9. The pressure bar testing device of claim 1, further comprising a plurality of clamps applied to a plurality of the 180 degree bend junctions.

10. The pressure bar testing device of claim 9, further comprising a plurality of strain gauges positioned on the central primary bar, a secondary bar that is adjacent to the central primary bar, and one of the secondary bars that is farthest in distance from the central primary bar.

11. The pressure bar testing device of claim 1, wherein the central primary bar has a width of approximately 8 mm and individual secondary bars have a width of approximately 4 mm.

12. The pressure bar testing device of claim 1, wherein the central primary bar and the secondary bars comprise steel bars.

13. The pressure bar testing device of claim 11, wherein each of the central primary bar and the second bars is separated from one another by approximately 0.2 mm.

14. The pressure bar testing device of claim 11, wherein individual lengths of the secondary bars are not uniform.

15. A method comprising:
joining a plurality of bar segments together at alternate ends with 180 degree bend junctions in a serpentine pattern to form a continuous path for wave propagation, wherein the plurality of bar segments comprise a central primary bar surrounded by two groupings of secondary bars,
wherein the central primary bar has an impact-end and an opposite end that connects to adjacent secondary bars with 180 degree bend junctions, wherein the adjacent secondary bars belong to the two groupings of secondary bars;
striking the central primary bar to generate a stress wave that propagates through the plurality of bar segments; and
measuring the propagating stress wave at one or more locations within the plurality of bar segments.

16. The method of claim 15, wherein the secondary bars are arranged in parallel to one another.

17. The method of claim 15, wherein a plurality of the second bars are oriented such that bend junctions of the plurality of the second bars orient in two orthogonal planes.

18. The method of claim 15, wherein individual lengths of the secondary bars are not uniform.

19. The method of claim 15, wherein a first serpentine mechanical waveguide formed of the plurality of bar segments is used an incident bar within a compact split Hopkinson pressure bar testing system, the method further comprising:
using a second serpentine mechanical waveguide as a striker bar within the compact split Hopkinson pressure bar testing system to strike the central primary bar of the first serpentine mechanical waveguide;
using a third serpentine mechanical waveguide as a transmission bar within the compact split Hopkinson pressure bar testing system; and
positioning a specimen between the incident bar and the transmission bar.

20. The method of claim 19, further comprising measuring amplitudes of reflected, incident, and transmitted waves along the first and third serpentine mechanical waveguides after striking the first serpentine mechanical waveguide with the second serpentine mechanical waveguide.
